(19) United States
(12) Patent Application Publication
(10) Pub. No.: US 2005/0151749 A1
(43) Pub. Date: Jul. 14, 2005

(54) Digital method of image display and digital display device

(76) Inventors: Didier Doyen, La Bouexiere (FR); Jonathan Kervec, Geveze (FR); Thierry Borel, Chantepie (FR)

Correspondence Address: Joseph S Tripoli;Thomson Licensing Inc, Patent Department, PO Box 5312, Princeton, NJ, 08543-5312, US

(21) Appl. No.: 10/505,603

(22) PCT Filed: Feb. 17, 2003
(86) PCT No.: PCT/EP03/01580

(30) Foreign Application Priority Data
Feb. 26, 2002 (FR) 02/02515

(51) Int. Cl. G09G 5/00

(52) U.S. Cl. 345/581

(57) ABSTRACT

The invention provides a solution for reducing the bit rate of the image memory which stores the binary images displayed on a digital display device. At least one binary image 16c is stored per group of at least two pixels of like binary value. Means duplicate the pixels of the image stored per group of pixels during display on a digital display element.

The invention relates to a digital method of image display and to a digital display device and in particular to a micromirror device.

Among display devices, digital display devices are devices comprising one or more cells which can take a finite number of illumination values. Currently, the finite number of values is equal to two and corresponds to an on or off state of a cell. To obtain a larger number of grey levels, it is known to resort to temporal integration carried out by the eye which consists in decomposing an image into a plurality of subimages of variable duration.

Among digital display devices, micromirror devices consist of a matrix of mirrors of very small dimension which can take two different tilts. An illumination light can be deflected in two different directions. The light deflected in one of the two directions is focused on a screen by optical means so that the screen is composed of a plurality of pixels which can only be on or off, each pixel being associated with a mirror. The micromirrors make it possible to deflect a luminous power big enough to make it possible to produce video projectors and back-projectors. Moreover, the micromirrors switch very rapidly and make it possible to minimize the negative effects related to temporal integration.

Conventionally, 256 grey levels per colour (red, green and blue) are used to define a colour video image. A binary decomposition makes it possible to use eight binary images of duration proportional to a power of two. Such a decomposition creates display defects in respect of the transitions of neighbouring grey levels which use very different binary images. Another problem stems from the large-area flicker which is caused in the uniform areas by a temporal grouping together of the images actually illuminated. To remedy these defects, it is known to divide the binary images of long duration into binary images of lesser duration and to distribute them homogeneously over the display time of an image while using one and the same stored binary image. Such improvements are disclosed in particular in U.S. Pat. No. 5,619,228 and No. 5,986,640. The bigger the number of binary images, the more noticeable the visual rendition.

Since micromirrors are relatively expensive components, the production of a cheap colour device is achieved by using a single micromirror circuit in front of which is placed a synchronized coloured wheel. The displaying of the colours is then carried out sequentially with the same micromirror circuit. On the basis of the image frequency and of the complete addressing time of the pixels constituting a micromirror circuit, it is possible to determine the maximum number of binary images that can be used to decompose a grey level corresponding to a colour. For a circuit which is fully addressable in 100 μs, it is possible with an image frequency of 50 Hz to have around 66 binary images based on grey levels, and with an image frequency of 60 Hz to have around 55 binary images.

If the limits of maximum operation which are permitted by micromirror circuits are taken into account, the rendition is excellent. On the other hand, another limit stems from the memory which stores the binary images. By way of example, if 66 binary images are used for each grey level with is an image frequency of 50 Hz on a micromirror circuit representing 768 lines of 1024 mirrors, the bit rate of the memory in read mode is equal to:
DR=768×1024×3×66×50=7.25 Gbits/s.

This memory must also be write accessible at a rate of:
DW=768×1024×3×8×50=900 Mbits/s.

The size of the memory is determined as a function of the content which corresponds for example to two images:
M=768×1024×3×8×2=36 Mbits.

If a memory structured as 32-bit words is used, it must operate at a frequency of 260 MHz. Such memories are very expensive. It is possible to reduce the operating frequency of the storage elements by using a memory structured as longer words or one divided into several memory banks operating alternately. The operating frequency of the memory is then reduced but this makes the management of the memory more complex and more expensive. If the resolution of the micromirror devices is increased, the bit rate is also increased. However, in order to decrease the cost of the display device of this type, it is vital to reduce the bit rate of the memory.

The invention provides a solution for reducing the bit rate of the image memory which stores the binary images displayed on a digital display device. At least one binary image is stored per group of pixels. The groups of pixels stored are duplicated during display.

The invention is a method for displaying an image on a digital display device comprising a display element displaying images of pixels which can only be on or off, in which each image is decomposed into a plurality of binary images with which a luminous weight is associated, each binary image being displayed once or several times during an image display period, the sum of the periods during which a binary image is displayed during the period of display of the image being proportional to the weight of the binary image. At least one binary image displayed several times is stored per group of at least two pixels of like binary value and for which the pixels are duplicated during each display of the image before being supplied to the display element.

The invention is also a digital display device comprising a display element displaying images of pixels which can only be on or off, storage means which store a plurality of binary images with which are associated luminous weights representative of the periods during which the binary images are displayed on the display element. At least one binary image is stored per group of at least two pixels of like binary value, and the device comprises duplication means which duplicate the pixels of the image stored per group of pixels during display.

According to one embodiment, the pixels are duplicated by multiplexing. According to another embodiment, the pixels are duplicated by repetitive reading of a buffer storing a line to be displayed.

Preferably, the display element is a micromirror matrix.

The invention will be better understood and other features and advantages will become apparent on reading the description which follows, the description making reference to the appended drawings among which:

FIG. 1 illustrates a sequence for displaying a grey level image according to the prior art,

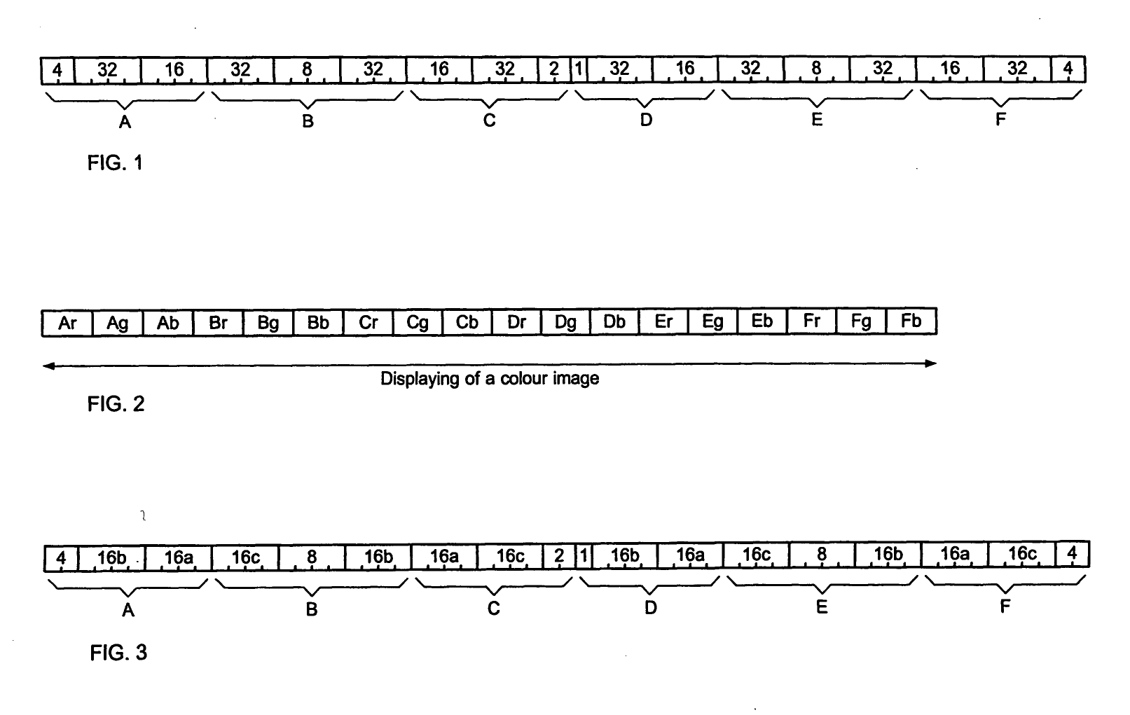

FIG. 2 illustrates the way in which a colour image is displayed,

FIG. 3 illustrates a sequence for displaying a grey level image according to the invention,

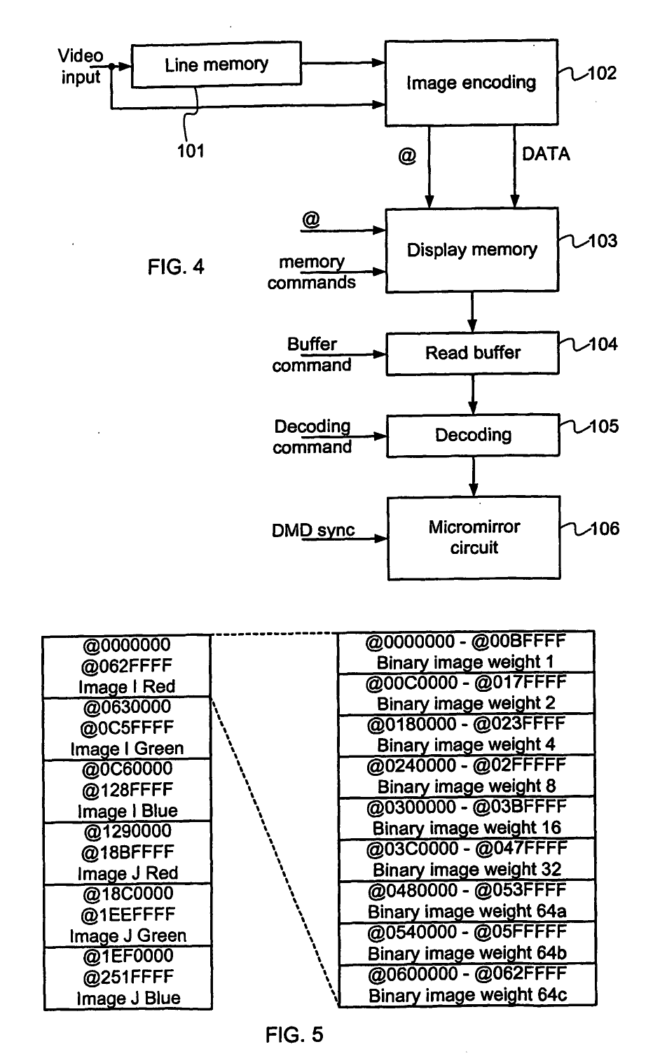

FIG. 4 shows the layout of a display device according to the invention,

FIG. 5 represents an exemplary layout of a memory plane according to the invention,

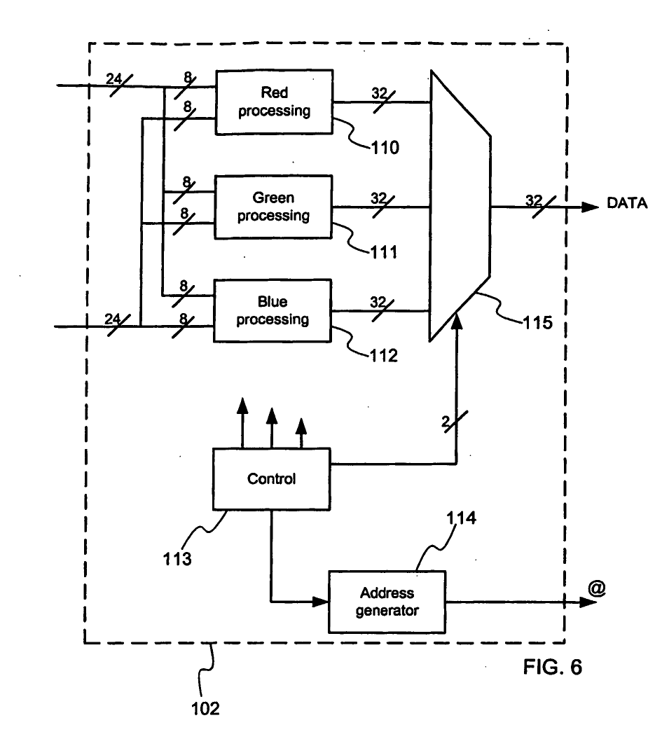

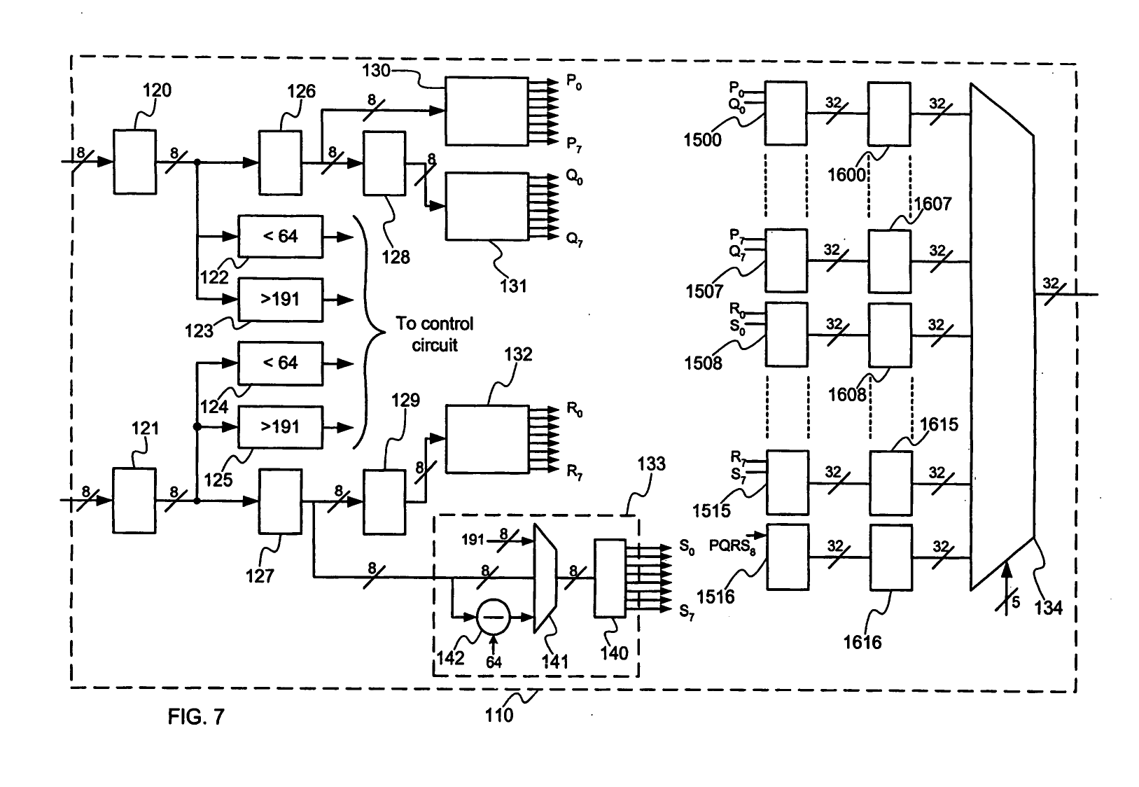

FIGS. 6 and 7 represent a preferred exemplary embodiment of a calculation circuit used in the invention, and

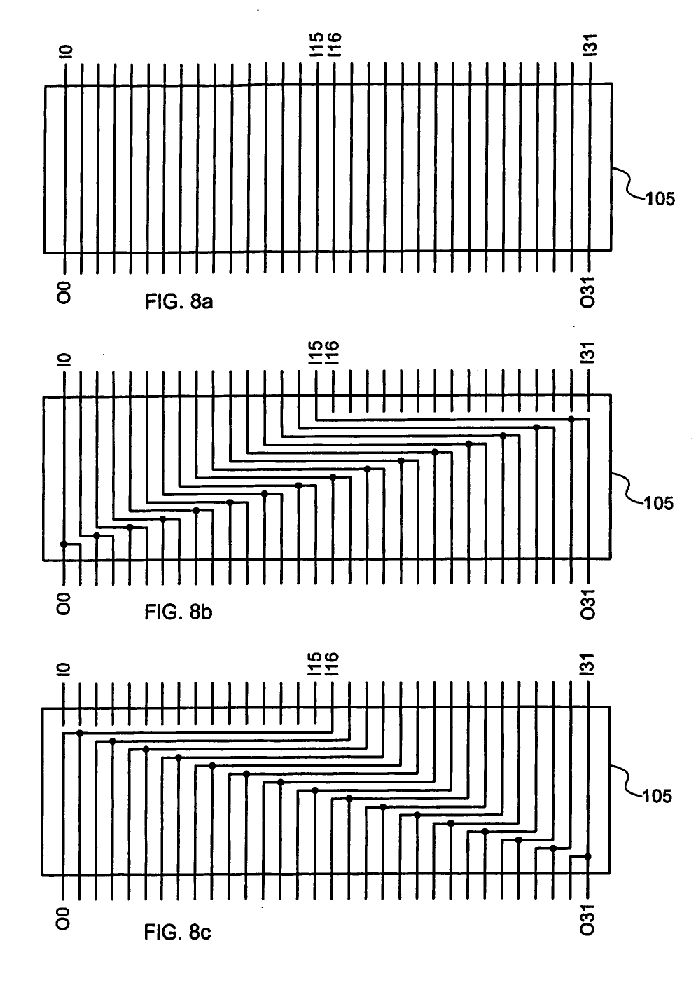

FIG. 8 illustrates the manner of operation of multiplexing elements used in one embodiment of the invention.

FIG. 1 illustrates the displaying of a grey level image on a micromirror display device such as known from the prior art. The displayed image comprises 64 grey levels decomposed into 6 binary images of respective weights 1, 2, 4, 8, 16 and 32. The binary images of weights 1 and 2 are displayed once for a duration proportional to their weight. The binary image of weight 4 is displayed twice for durations proportional to the weight 2. The binary images of weights 8, 16 and 32 are displayed respectively 2, 4 and 8 times for durations proportional to the weight 4, the various images being distributed homogeneously throughout the duration of display of the image. The weights associated with the binary images being indicated in the boxes whose size in FIG. 1 is proportional to the duration of display.

The representation given in FIG. 1 is limited to 64 grey levels for reasons of clarity of representation. For a video system, it is common to have 256 grey levels. The decomposition is then effected over 8 binary images of respective weights 1, 2, 4, 8, 16, 32, 64 and 128. It is then possible to have a similar decomposition where the image of weight 4 is decomposed into two images of weight 2, and the images of weights 8, 16, 32, 64 and 128 decomposed into respectively 2, 4, 8, 16 and 32 images of weight 4. The displaying of an image will be achieved with the aid of a succession of 66 images of luminous weights varying between 1 and 4 which correspond to 8 stored binary images.

By referring to U.S. Pat. No. 5,619,228 and No. 5,986,640, the person skilled in the art will note that other decompositions are possible over varied numbers of displayed images.

To obtain a colour image with the aid of a single display element, the luminous distribution of FIG. 1 is segmented for example into 6 groups A to F. In order to have groups A to F of like duration, it is known to insert durations where the micromirrors do not restore any light, into certain groups. The groups A to F corresponding to the grey level of a colour are interleaved for example as shown in FIG. 2. The groups Ar to Fr correspond to the colour red. The groups Ag to Fg correspond to the colour green. The groups Ab to Fb correspond to the colour blue. A coloured wheel synchronized with the displaying of the various groups passes in front of the display element and transforms the grey levels into coloured levels. The integration of the eye restores the colours.

FIG. 3 represents the displaying of an image as grey levels according to the invention. The luminous distribution is effected according to a similar distribution to that of FIG. 1. However, the image of weight 32 is here divided into two images of weight 16, 16a referring to the original image of weight 16, and the notation 16b and 16c referring to two images of weight 16 resulting from the division of the image of weight 32. The temporal distribution of the displays of binary images 16b and 16c is effected alternately with respect to the display of the image 32 and is distributed over the entire display time of an image.

The number of binary image readings is the same as for a display according to the prior art. However, one of the binary images, for example the image 16c, resulting from the division of the binary image of high weight corresponds to a binary image where the pixels are stored per group of four pixels. The size of the image memory is increased accordingly. On the other hand, the reading of the binary image 16c requires 4 times less bit rate than for a normal binary image. As the binary image 16c is read four times in this example, this amounts to dispensing with the reading of three images in terms of reading time while retaining the same luminous distribution.

For an image using 256 grey levels per colour (red, green and blue), only the binary image of weight 128 is divided into two binary images of weight 64. The division of the binary image of highest weight 128 is decomposed into a conventionally stored specific binary image of weight 64 and into a common binary image of weight 64 which is stored per group of pixels. A grey level is decomposed into 9 binary images of respective luminous weights 1, 2, 4, 8, 16, 32, 64a, 64b and 64c. The luminous distribution is effected according to a technique corresponding to that of FIG. 3. A pixel can take 256 values lying between 0 and 255 for each colour. However, the value of a grey level for a colour is decomposed into a common value equal to 0 or 64 and a specific value lying between 0 and 191. The common value corresponds to a value common to the group of pixels used to store the image.

For a display device intended for displaying video images, the degradation of the resulting image is almost zero if the group of pixels is limited to adjacent pixels corresponding to two adjacent lines and two adjacent columns. Indeed, a statistical study of video images shows that it is rare to have contrasts of an amplitude of 128 on filmed images or images aspiring to look like filmed images.

During the encoding of an image in the display memory, the grey levels corresponding to one and the same colour are compared for four pixels belonging to two neighbouring columns and lines. If the four grey levels are greater than the level 64 then the pixel of the common binary image of weight 64c is activated, next 64 is subtracted from the grey levels and the resulting values are coded with the aid of the specific binary images namely the binary images 1, 2, 4, 8, 16, 32, 64a and 64b. If one of the four grey levels is less than 64 then the grey levels greater than the level 191 are truncated to the level 191, the pixel of the common binary image of weight 64c is inactivated and the grey levels are coded with the aid of binary images 1, 2, 4, 8, 16, 32, 64a and 64b. By way of example, Table 1 hereinbelow represents three examples where the various coding possibilities are implemented.

TABLE 1

| Group of | States of the binary images of weight: | | | | | | | | |
|---|---|---|---|---|---|---|---|---|---|
| grey levels | 1 | 2 | 4 | 8 | 16 | 32 | 64a | 64b | 64c |
| 95 | 1 | 1 | 1 | 1 | 1 | 0 | 0 | 0 | 1 |
| 112 | 0 | 0 | 0 | 0 | 1 | 1 | 0 | 0 | 1 |
| 234 | 0 | 1 | 0 | 1 | 0 | 1 | 1 | 1 | 1 |
| 196 | 0 | 0 | 1 | 0 | 0 | 0 | 1 | 1 | 1 |
| 95 | 1 | 1 | 1 | 1 | 1 | 0 | 1 | 0 | 0 |
| 112 | 0 | 0 | 0 | 0 | 1 | 1 | 1 | 0 | 0 |
| 167 | 1 | 1 | 1 | 0 | 0 | 1 | 1 | 1 | 0 |
| 47 | 1 | 1 | 1 | 1 | 0 | 1 | 0 | 0 | 0 |
| 57 | 1 | 0 | 0 | 1 | 1 | 1 | 0 | 0 | 0 |
| 112 | 0 | 0 | 0 | 0 | 1 | 1 | 1 | 0 | 0 |
| 234 | 1 | 1 | 1 | 1 | 1 | 1 | 1 | 1 | 0 |
| (coded 191) | | | | | | | | | |
| 196 | 1 | 1 | 1 | 1 | 1 | 1 | 1 | 1 | 0 |
| (coded 191) | | | | | | | | | |

In Table 1, a 1 level signifies that the pixel of the binary image of weight is on, the 0 level corresponds to an off pixel. In case of truncation, the truncated grey level generally corresponds to a transition between two objects. The visible defect corresponds to a slight blur on the pixel or pixels considered. If the image is moving, the blur is masked by the motion of the image.

The structure of the display device, implementing the display technique of the invention, is described with the aid of FIG. 4. The numerical data expressed correspond to a choice of image format of 768 lines of 1024 pixels with an image frequency of 50 Hz.

A digital video signal is supplied on a video input. The video signal is a progressive RGB type signal containing the succession of pixels to be displayed, each pixel being coded for example on 24 bits (8 per colour), the pixels being supplied line by line successively. The video signal corresponds to the signal to be displayed, any corrections performed on the video signal (transcoding to RGB format, gamma correction, correction of colours, of contrast or the like) are performed previously with the aid of known means (not represented).

A delay circuit 101 delays the video signal by one line. The delay circuit 101 is for example a memory whose capacity makes it possible to store a line, the video signal is supplied to the memory on a 24-bit bus. The memory must therefore have a capacity of 24 Kbits (1 Kbit=1024 bits) and operate at a frequency of 39.3 MHz.

An image encoding circuit 102 receives on the one hand the digital video signal and on the other hand this same signal delayed by one line by the delay circuit 101. The encoding circuit 102 carries out the abovementioned coding and records in a display memory 103 the binary images to be displayed.

The display memory 103 is a very fast memory furnished with separate read and write ports. This display memory 103 has a pagewise reading mode making it possible to reduce read access times. The addresses @ and data DATA to be written are supplied by the encoding circuit 102. The reading addresses and the control signals for the display memory 103 are supplied by a control circuit (not represented). The data read from the display memory 103 are supplied to a read buffer 104. The data are processed per 32-bit word.

The read buffer 104 is for example a very fast FIFO memory structured as 32-bit words. The read buffer 104 caters for the regulation of the bit rate of the display memory 103. The read buffer 104 comprises means, for example registers, which make it possible to perform the duplication of a line of the stored common binary image. Registers storing the line of the common binary image are read twice before taking a new value. The data entering and leaving the read buffer 104 are structured as 32-bit words.

A decoding circuit 105 is placed between the read buffer 104 and a micromirror circuit 106. The decoding circuit 105 caters for the duplicating of the pixels of the common binary images on the columns. The decoding circuit 105 consists for example of multiplexing means which make it possible to direct the data differently as a function of the type of binary image.

As far as the layout of the various elements is concerned, it is appropriate to detail a few features required for a proper understanding of the device.

FIG. 5 represents a memory plane such as used for the storing of binary images. Such a memory plane is divided into two planes of images I and J. The image I is read so as to be displayed while the image J is being written; then the image J is read while the next image is written instead of the image I. Each image plane is divided into a colour plane specific to each colour red, green and blue. Each colour plane is thereafter divided into binary images of respective weights 1, 2, 4, 8, 16, 32, 64a, 64b and 64c. Such an arrangement serves to carry out memory readings in page mode or burst mode which make it possible to decrease the memory read access times.

The read buffer 104 is a memory of smaller dimension than the display memory 103 and can have faster access times. To calculate the size of the read buffer 104, several parameters need to be taken into account. In the preferred exemplary embodiment, the bit rate of the memory 102 at output is equal to:
DS=768×1024×(50+16/4)×8×3×50=5.93 Gbits/s.

The coefficient 16/4 arises from the fact that the common binary image is displayed 16 times while the memory read time is divided by the number of pixels grouped together during storage which corresponds to 4.

The instantaneous bit rate for a specific binary image at the output of the read buffer 104 is equal to: 7.25 Gbits/s. The instantaneous bit rate for a common binary image at the output of the read buffer 104: 3.625 Gbits/s.

However, the buffer 104 duplicates the pixels and the information bit rate relative to the memory 102 is equal to 1.81 Gbits/s.

By using a single micromirror device displaying colours sequentially, the maximum number of specific binary images between two readings of a common binary image can vary between 2 and 6. The read buffer should never empty and should never saturate. A memory buffer with a capacity of 2 binary images i.e. 192 kilobytes is suitable.

Incidentally, the person skilled in the art may observe that the bit rate of the memory 103 is 5.93 Gbits/s instead of 7.25 Gbits/s i.e. a gain of 18% in operating speed for a given architecture.

The encoding circuit 102 will determine the binary images to be displayed according to the process stated previously. Although the operations to be performed are not very complex, the operating speed is high. FIG. 6 represents an exemplary embodiment of the encoding circuit 102. The two video inputs are buses of 24 bits which contain the information relating to two pixels of two adjacent lines. The grey levels specific to each colour are directed to three identical processing circuits 110, 111 and 112. Each processing circuit supplies words on 32 bits representing a succession of pixels of one and the same binary image. A control circuit 113 supplies the various commands to be applied to the processing circuits 110 to 112 and synchronizes the words leaving the processing circuits 110 to 112 with an address @ originating from an address generating circuit 114. The address generating circuit 114 scans the memory plane of the various binary images to be recorded so as to store the words of each binary image in the right place. A multiplexer 115 directs the words originating from the various processing circuits to the data output DATA.

FIG. 7 details a processing circuit 110. First registers 120 and 121 store the grey levels of two adjacent lines originating from the two inputs. Comparison circuits 122 to 125 are linked to the first registers 120 and 121 so as to compare the grey levels with a minimum threshold 64 and with a maximum threshold 191. The comparison circuits supply the result of the comparison to a control circuit (not represented). Second registers 126 and 127 are linked to the first registers 120 and 121 for storing the content of the first registers after comparison. Third registers 128 and 129 thereafter store the content of the second registers 126 and 127. When the content of the second registers and third registers 126 to 129 corresponds to four pixels grouped together on the common binary image, calculation circuits 130 to 134 define the grey level to be coded, as a function of commands given by the control circuit as a function of the tests performed.

To this end, each calculation circuit comprises a result register 140 which stores the grey level to be coded, a multiplexer 141 linked to the input of the result register 140 makes it possible to choose the result datum from among the value 191, the grey level or the grey level from which the value 64 has been subtracted with the aid of a subtraction circuit 142. The choice made by the multiplexer 141 is determined by the control circuit as a function of the result of the various comparisons performed according to the process explained previously.

The bits of like weight leaving the result registers 140 corresponding to one and the same line are directed to one and the same shift register 1500 to 1515. Each shift register 1500 to 1515 is a 32-bit register having two inputs and shifting the data by one bit with each active edge of the clock, the calculation circuits supplying a new result every two active edges of the clock, so that after having received 16 groups of 4 grey levels, each shift register 1500 to 1515 contains a word of 32 bits corresponding to 32 consecutive pixels of a specific binary image. Buffer registers 1600 to 1615 store the content of the shift registers 1500 to 1515 from the moment the latter contain the 32-bit words up to the writing to the display memory 103. A shift register 1516 serves to store the bit corresponding to the common binary image which is supplied by the control circuit as a function of the result of the comparison. The shift register 1516 receives a single bit at a time and the shift is effected only one time out of two relative to the registers 1500 to 1515. A buffer register 1616 stores the content of the shift register 1516 from the moment the latter contains 32 bits and until transfer to the display memory 103. A multiplexer 134 selects one of the buffer registers 1600 to 1616 in order to supply it on the output of the processing circuit 110.

The decoding circuit 105 consists of multiplexing means whose various connections are described with the aid of FIG. 8. When the binary image read from the display memory 103 is a specific binary image, the inputs I0 to I31 are coupled directly to the outputs O0 to O31, as represented in FIG. 8a. When the binary image read is a common binary image, the decoding circuit first takes the position of FIG. 8b which transposes the 16 bits of low weight corresponding to the inputs I0 to I15 onto the 32 outputs O0 to O31 by duplicating the data, then the position of FIG. 8c which transposes the 16 bits of high weight corresponding to the inputs I16 to I31 onto the 32 outputs O0 to O31 by duplicating the data. The simple switching of the multiplexing means from the position of FIG. 8b to the position of FIG. 8c replaces the reading of two consecutive words from the buffer 104.

Other variants of the invention are possible. In the preferred example, a single common binary image with groups of 4 pixels is used. It goes without saying that it is possible to use groups of only two pixels corresponding to adjacent lines or columns. If only a pixel grouping based on adjacent columns is employed, then the duplication is performed solely in the decoding circuit. If a grouping based on adjacent lines is performed, the duplication is performed solely by successive reading of the same data from the read buffer 104. In both cases, the encoding circuit 102 can be simplified.

It is also possible to use two or more common binary images so as to reduce the truncation errors, each common image being common to a different group of pixels. It being possible for a pixel group to correspond to a group of four pixels and another group corresponding to a pair of pixels. In the example described, the memory buffer stores two binary images since display is carried out binary image by binary image. It is possible to use an interleaved mode of image display or the display of the binary images is carried out per group of lines. Regulation is then carried out on groups of lines instead of images. The memory buffer can then be reduced since only a few lines have to be stored.

Preferably, it is chosen to have a common binary image whose luminous weight corresponds to the highest weight of the specific binary images. This choice is made since it makes it possible to have an appreciable reduction in the bit rate of the memory without engendering appreciable defects on a video image. The person skilled in the art will be able to choose a different value as a function of the bit rate constraint and image quality constraint.

The preferred example relates to a device using micromirrors. The invention can be used on other digital display devices which use a similar display technique. Also, reference is made to a system having a resolution of 768×1024 pixels and which uses a display based on 66 luminous segments of weight lying between 1 and 4 for each grey level. The changing of the resolution and of the luminous distribution can change independently of the invention.

1. Method for displaying an image on a digital display device comprising a display element displaying images of pixels which can only be on or off, in which each image is decomposed into a plurality of binary images with which a luminous weight is associated, each binary image being displayed once or several times during an image display period, the sum of the periods during which a binary image is displayed during the period of display of the image being proportional to the weight of the binary image, wherein at least one binary image displayed several times is stored per group of at least two pixels of like binary value and for which the pixels are duplicated during each display of the image before being supplied to the display element.

2. Method according to claim 1, wherein the pixels are duplicated by multiplexing.

3. Method according to claim 1, wherein the pixels are duplicated by repetitive reading of a buffer storing a line to be displayed.

4. Method according to claim 1, wherein the image for which the pixels are duplicated corresponds to an image whose weight is at least equal to the highest weight of the other binary images.

5. Digital display device comprising:
a display element displaying images of pixels which can only be on or off,
storage means which store a plurality of binary images with which are associated luminous weights representative of the periods during which the binary images are displayed on the display element,
wherein at least one binary image is stored per group of at least two pixels of like binary value, and in that the device comprises duplication means which duplicate the pixels of the image stored per group of pixels during display.

6. Device according to claim 5, wherein the duplication means are multiplexing means.

7. Device according to claim 5, wherein it comprises a memory buffer placed between the display element and the storage means which regulates the information bit rate.

8. Device according to claim 7, wherein the memory buffer is one of the duplication means which stores at least one binary image line.

9. Device according to claim 5, wherein the display element is a micromirror matrix.
